(19) United States
(12) Patent Application Publication
(10) Pub. No.: US 2004/0010512 A1
(43) Pub. Date: Jan. 15, 2004

(54) Interactive system and method for the dissemination of information on an event

(75) Inventors: Matthew W. Smith, Allen, TX (US); Kristi Lusk, Allen, TX (US)

Correspondence Address: Michael L. Diaz, Michael L. Diaz, P.C., 555 Republic Drive, Suite 200, Plano, TX, 75074, US

(73) Assignee: Incursion Technologies, Inc.

(21) Appl. No.: 10/193,809

(22) Filed: Jul. 12, 2002

(51) Int. Cl. G06F 17/00

(52) U.S. Cl. 707/104.1

(57) ABSTRACT

A system and method of disseminating information about an event to guests of the event and the host of the event. The system includes a computing system storing information about the event. The system also includes a host terminal operable by the host and a guest terminal operable by the guest. Each terminal may communicate with the computing system. The computing system generates an electronic invitation for delivery to each guest selected by the host. The electronic invitation provides information about the event and a response prompt. The response prompt provides the guest the ability to provide the guest's intentions in attending the event. The response prompt sends a signal to the computing system indicating the guest's intentions. The computing system may then compile a list of guests for use by the host. In addition, the computing system may generate an interactive web site providing additional information on the event.

### BACKGROUND OF THE INVENTION

1. Technical Field of the Invention

This invention relates to event planning and, more particularly, to a system and method providing dissemination of information to a host and guests of an event.

2. Description of Related Art

Events such as weddings, graduations, and seminars are prevalent in many aspects of our lives. Oftentimes, details of events can be very complex. For example, the planning and implementation of weddings can be incredibly tedious and difficult. First, a bride and groom create a list of guests they wish to invite to their wedding. Typically, the bride and groom then send out wedding invitations inviting the people from the list to their wedding. The wedding invitation usually requires a response by the invited guest indicating whether the guest plans to attend the wedding. The invitation also provides limited information to the invited guest, mostly information on the time and place of the wedding. Once the bride and groom receive responses from the invited guests, a definitive number of guests is determined. From this determined number, the bride and groom are able to plan the details of the wedding events (e.g., number of meals). However, difficulties arise in this process. First, the invitation is rarely personalized for each bride and groom. Mostly, the invitation is a textual message merely providing information on the upcoming wedding. There is very little creativity involved in the written invitation. In addition, the response process to determine who will attend the wedding is primitive. A list must be manually compiled from the received responses. This list, since it is manually compiled, is prone to error in name, number and type of response. Also, invitations only offer basic information on the wedding. However, there are many items which are often overlooked on the invitation and must be received by word of mouth. For example, if a gift registry has been created at a particular store or stores, the information is not often included in the wedding. Also, if there are out of town guests, hotel accommodations are not included. Driving directions to the events of the wedding are also not usually provided within the invitation. Other types of information which are rarely enclosed with the invitation include type of dress, theme of the wedding, type of food being served, possible amenities offered at the wedding location, etc. Currently, there is no system or method which allows both the guest and the host to interactively provide and receive information on an event, such as a wedding.

Although there are no known prior art teachings of a solution to the aforementioned deficiencies and shortcomings such as that disclosed herein, prior art references that discuss subject matter that bears some relation to matters discussed herein are U.S. patent application Ser. No. 2002/0001102 to Williams (Williams), U.S. patent application Ser. No. 2001/0014867 to Conmy (Conmy), U.S. patent application Ser. No. 2002/0065893 to McCormack (McCormack), and U.S. patent application Ser. No. 2002/0069097 to Conrath (Conrath).

Williams discloses a personalized magazine commemorating an event. The magazine includes a plurality of pages, each of the pages comprising at least one photograph related to the event and textual matter associated with the photograph. The pages are bound together to create the personalized magazines. However, Williams does not teach or suggest an interactive event planner and organizer. Williams merely discloses a method of creating a personalized magazine.

Conmy discloses a network based electronic calendaring system for use by several users. The system includes one or more databases which store a profile for each potential invitee of the system. The invitee profile may include a user profile that contains information regarding available and unavailable times for that user. The calendaring system allows a user to request allocation of a time interval for one or more of the invitees. The calendaring system then gathers the profiles for each of the invitees and determines whether each of the invitees is available during the requested time interval. However, Conmy does not teach or suggest an interactive system allowing the invitee and host to provide information to each other concerning the event. Conmy merely is a calendar system for deconflicting invitees' schedules.

McCormack discloses a method and apparatus for inviting individuals to events. The method includes sending audio and visual data stored on a storage media. The data includes a basic invitation and additional desired information, including the time and date of the event as well as directions to the event location. Once completed, the invitation is enclosed in a case and delivered to the prospective guests. The invitation is operable on a CD player. Additionally, an RSVP prompt is provided with the invitation which allows the guest to response to the host via the Internet. McCormack merely discloses an electronic invitation. McCormack does not teach or suggest an interactive system for use by the guest and host for providing information beyond the invitation disclosed in McCormack.

Conrath discloses a system and method utilizing an “Organizational Directory Management Services” (ODMS) approach to maximize a needed business management tool. The ODMS is used to collect and analyze data for scheduled events, such as collecting data regarding the planning of a wedding. However, Conrath does not teach or suggest providing an interactive system enabling the guests and host to provide information to each other about the event.

Thus, it would be a distinct advantage to have a system and method which enables both the guest and host to interactively provide information to each other concerning a scheduled event. It is an object of the present invention to provide such a system and method.

### SUMMARY OF THE INVENTION

In one aspect, the present invention is a system for disseminating information about an event. The system includes a computing system for disseminating information about an event to a host and a guest. A host terminal communicates with the computing system and is operable by the host of the event. A guest terminal communicates with the computing system and is operable by the guest of the event. The computing system stores information about the event and generates an electronic invitation on the event for the guest. The computer may optionally generate a web site for the dissemination of information of the event.

In another aspect, the present invention is a system for disseminating information about an event. The system includes a computing system for disseminating information about an event to a host and guests. In addition, the system includes a host terminal and guest terminal for communicating with the computing system. The computing system stores information about the event and generates an electronic invitation on the event for the guest. The electronic invitation also has a response prompt for communicating with the computing system the guest's intention in attending the event. The computing system compiles a list of guests intent on attending the event. The computing system may also generate a web site for disseminating information about the event.

In still another aspect, the present invention is a method of disseminating information about an event to a guest from a host hosting the event. The method begins by the host inputting information about the event to a computing system. Next, the inputted information is stored by the computing system. The computing system then generates an electronic invitation from the host for the guest. The electronic invitation includes information about the event and delivers the electronic invitation to the guest. The guest then sends a response on the guest's intention in attending the event to the computing system. The computing system then generates a web site providing details on the event. The guests then access the web site to gain additional details of the event.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating the components of a system for use in planning, organizing and disseminating information in the preferred embodiment of the present invention; and

FIGS. 2A-2C are flow charts outlining the steps for the guests and the host to interact with the computing system according to the teachings of the present invention.

### DETAILED DESCRIPTION OF EMBODIMENTS

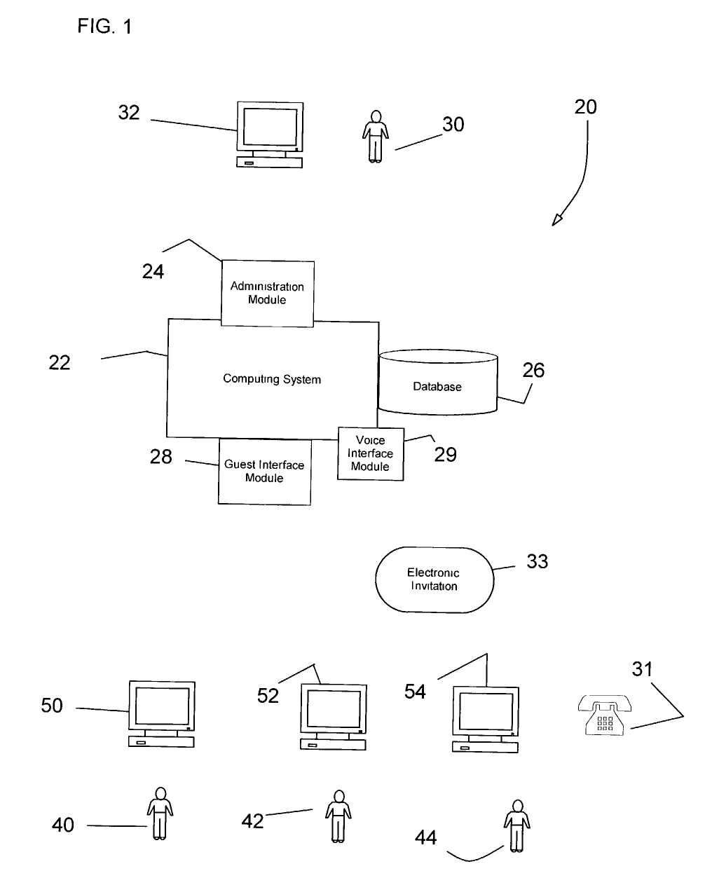

The present invention is a system and method providing interactive event organization and information to invitees and hosts of an event. FIG. 1 is a simplified block diagram illustrating the components of a system 20 for use in planning, organizing and disseminating information in the preferred embodiment of the present invention. The system 20 includes a computing system 22 having an administration module 24, a database 26, and a guest interface module 28. A host 30 communicates through a host terminal 32 with the computing system 22 via any conventional communications link, such as the Internet. The system 20 also includes several guests 40, 42, and 44 communicating through guest terminals 50, 52, and 54 to the computer system 22. The number of guests and associated guest terminals are used for illustrative purposes only, and it should be understood that any number of guests and terminals may be utilized in the system 20.

The host terminal 32 may be any device, such as a desktop computer, laptop computer, or personal digital assistant (PDA), enabling the host 30 to communicate with the computing system 22. In the preferred embodiment of the present invention, the host terminal is a conventional computer having a link via the Internet with the computing system 22.

The guests 40, 42, and 44 also communicate with the computing system 22 through terminals. The guest terminals may also be any device, such as desktop/laptop computer or PDAs, allowing communication with the computing system.

The computing system provides storage of information through the database 26, as well as communicating with the guests 40, 42, and 44 through the guest interface module 28. The computing system also communicates with the host 30 through the administration module 24. The guest interface allows the guest to provide information, as well as receive information stored within the database 26. In addition, the administration module enables the host to securely communicate with the computing system. In the preferred embodiment of the present invention, the administration module may only be accessed by the host. The computing system also includes a voice interface module 29 which enables any guest or host to call on any telephone 31 and obtain information over the telephone.

With reference to FIG. 1, the operation of the system 20 will now be explained. The system 20 is utilized in the planning, announcing and implementation of a scheduled event. In one embodiment, the scheduled event is a wedding and the host is the bride/groom. As illustrative of operation of the system 20, the description of the system 20 is explained in terms of a wedding. The host 30 determines the guests for whom he/she desires to invite to the wedding. The lists of guests should include their corresponding address and optionally their email address. In addition, the host may also compile a list of accommodations located near the wedding/reception area. For example, the host may provide reservations or options of possible hotel accommodates for their guests.

Additionally, the host may include detailed instructions on the planned events, such as type of appropriate dress, time and place of each event, and type of food or beverages provided at the scheduled event. Additionally, the host may provide registry information, including a link and reference code to a possible store's web site to which the host is registered. Each invitation may be personalized for each guest. The information supplied by the host may also indicate specific guest lists for which only certain guests are invited, such as a rehearsal dinner.

The information compiled by the host is sent to the computing system 22 through the host terminal 32. To assist in obtaining the appropriate information, the host is assisted in determining the appropriate information by a series of question prompts sent from the computing system through the administration module 24. The prompts are stored within the database 26 and query the host on possible information which the host may wish to disseminate to the guests.

In addition, the administration module provides several options in the form of templates for use in a formalized invitation which may be optionally sent to the guests. Specifically, the templates may include different type of colors (which may be optionally corresponding to the theme colors of the wedding), and formatted types of formal invitations (e.g., fonts, invitation style, etc.). The administration module also gives a prompt for the insertion of audio recordings for background music to be place on the invitation. In addition, the administration module prompts the host for photographs of people and places associated with the bride and groom. For example, various stages of the bride and grooms life may be displayed. This information is then automatically compiled and sorted into an invitation for each guest.

The computing system 22 creates an electronic invitation 33 for each guest. The electronic invitation may include the guest's name and address, directions to the location of the wedding events, audio and visual recordings associated with the bride and groom and their wedding. The electronic invitation may be sent to the guests through any electronic media, such as a compact disc/mini-disc which is mailed to each guest, or through an email message via the Internet. It should be understood that any electronic communication device or method conveying the information may be used to send the created electronic invitation to the guests.

The electronic invitation 33 may also be used as a conduit to a wedding web site generated by the guest interface module 28 providing additional information as well as a respond function. The electronic invitation may include a prompt to “accept” or “decline” the invitation. If the guest desires to accept the invitation, the guest may click on an “accept” prompt provided in the electronic invitation. The electronic invitation may also query the guest for number of guests attending the wedding. The electronic invitation then attempts to connect through an Internet connection of the guest terminal to the guest interface module. If accepted, the electronic signal sends a positive response as well as a guest identifier to the guest interface module. The guest interface module may then provide the name and number of guests accepting the invitation for storage in the database 26. In the alternative, if the guest decides to decline the invitation, the guest may select the “decline” prompt. The electronic invitation may then send a negative signal and guest identifier to the guest interface module, which in turn, stores the information in the database. The host may access the list of accepting guests and declining guests for planning purposes.

The guest interface module 28 may also generate a wedding web site for the dissemination of information. For example, the wedding web site may supply more specific information on the accommodation options, local attractions, and specific events of the wedding. Additionally, an address may either be manually inputted or the address provided by the electronic invitation may be used to give driving directions to the various wedding events.

The wedding web site may be reached by manually selecting the web site from the guest terminal's web browser. In addition, the electronic invitation may include a prompt for connecting to the web site. Upon reaching the web site, the web site may also provide for receipt of an identifying signal sent from the electronic invitation to the wedding web site. The wedding web site may also include a hyperlink to the guest registry of one or more stores accommodating the bride and groom. In an alternate embodiment of the present invention, the bride and groom may provide a “wish list” directly on the wedding web site.

The host (bride and groom) may post additionally data on the wedding web site by accessing the web site through the administration module 24. For example, further details, amended plans, photographs, etc. may constantly be added or modified by accessing the administration module. By accessing the administration module 24 through the host terminal 32, the host may also obtain the current list of the accepting guests for use in planning the wedding.

The guests may also access information from the computing system through the voice interface module 29. The guest may receive information via the telephone 31. The telephone 31 may communicate with the voice interface module either through a landline or wireless link. Upon calling a telephone number displayed on the electronic invitation and the wedding web site, the guest may verbally request information about the wedding. For example, the guest accesses the voice interface module and ask the time of the wedding ceremony, driving directions, etc. The voice interface module receives the request, interprets the request, accesses the database and obtains the requested data. The voice interface module then verbalizes the obtained data and supplies the verbalization to the guest listening on the telephone. Voice recognition/interactive systems for various other systems are well known and may be implemented within the system 20.

Once the wedding has been completed, the computing system automatically or manually transitions to a commemorative mode on wedding web site. The web site may now be used to commemorate the wedding activities with photographs of the wedding or other associated events (e.g., honeymoon). The web site may also provide other relevant data to the guests and host, such as attending guests. In addition, after a specific period of time, the computing system may automatically create an electronic commemorative file containing relevant information, such as photographs, the invitation, wedding list and attending guests, etc. The commemorative file may be stored on a storage device such as a CD or mini-disc.

In an alternate embodiment of the present invention, the computing system 22 may reside within the host terminal 32 providing some or all of the functions of the computing system discussed above. For example, a program may be installed into the host terminal enabling the host to create the electronic invitation. The electronic invitation may then be created and sent out. The creation of a wedding web site may be made within a computing system within the host terminal or remotely at an additional computing system.

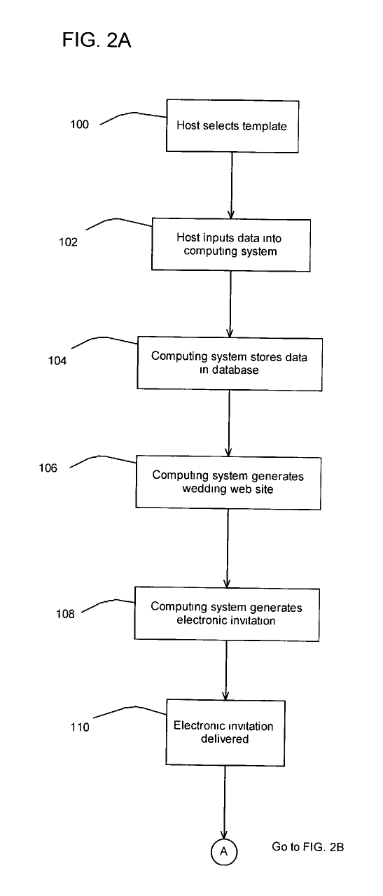

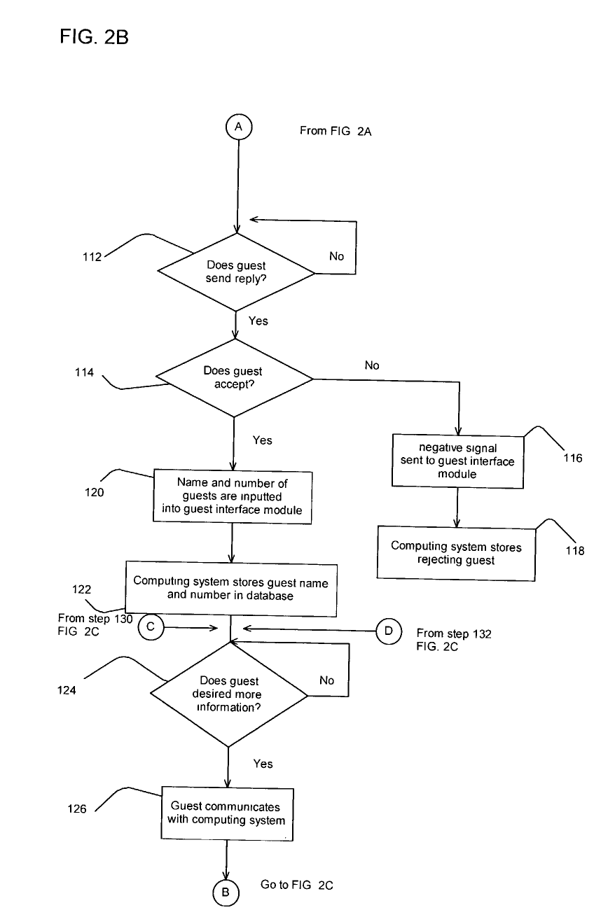

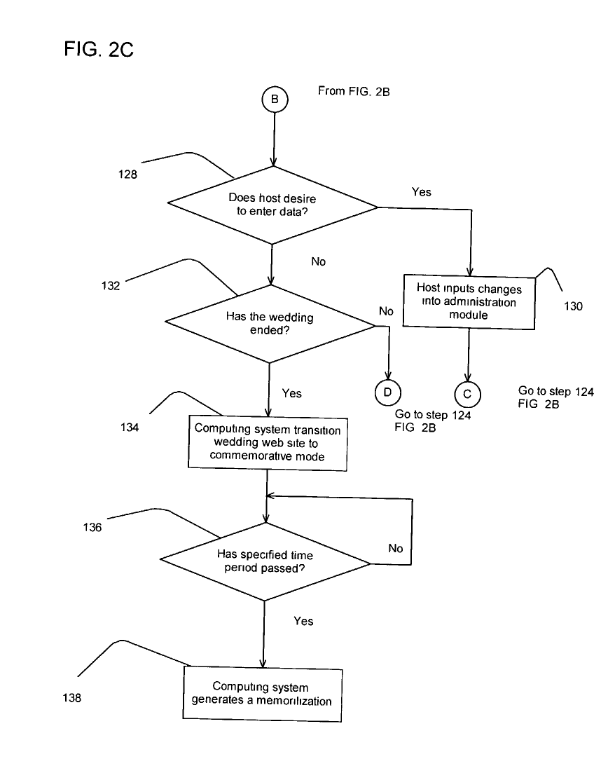

FIGS. 2A-2C are flow charts outlining the steps for the guests 40, 42, and 44 and the host 30 to interact with the computing system 22 according to the teachings of the present invention. With reference to FIGS. 1, 2A, 2B, and 2C, the steps of the method will now be explained. As discussed above, the event is shown as a wedding. However, this is merely illustrative of the various types of events which may be used, such as graduations, baptisms, seminars, and anniversaries. The method begins with step 100 where the host selects a template for which the host desires to display on the electronic invitation 33. The template may include a specified format and/or color background. The host is provided with a selection of templates by the computing system 22. The host communicates with the computing system 22 through the host terminal 32 and a communication link (e.g., via the Internet). In an alternate embodiment of the present invention, the host is provided the selections of the templates by inserting a program storing the selections and prompts into the host terminal. Next, in step 102, the host inputs data to the computing system or host terminal. The data may include name and dates of guests, event activities, times, locations, audio recording (song), and photographs associated with the host.

Next, in step 104, the computing system stores the data and host selections within the database 26. In step 106, the computing system 22 generates a wedding web site. The wedding web site may provide various data, including even more details, for release to the guests. In step 108, the computing system also generates an electronic invitation, based on the selection of a template in step 100, and the information provided by the host to the computing system. The electronic invitation may be stored as an electronic message in a computer or storage device, such as a CD or mini-disc. Alternately, the host terminal stores the selections and generates the electronic invitation. Next, in step 110, the electronic invitation is delivered to each guest. The electronic invitation may be delivered via private or public mail carrier or via electronic means, such as an email message delivery over the Internet. The invitation includes the name and address of each individual guest. In addition, the electronic invitation may include a response prompt for RSVP purposes.

In step 112, it is determined if the guest sends a reply to the response prompt on the electronic invitation. If it is determined that the guest does not send a reply, the step continues to standby at step 112 until a response has been selected by the guest. However, if it is determined that the guest does send a reply, the method moves form step 112 to step 114, where it is determined if the guest has accepted the invitation. If the guest does not accept the invitation and selects a negative reply, the method moves to step 116, where the electronic invitation sends a negative signal and guest identifier to the computing system 22 through the guest interface module 28. Next, in step 118, the computing system identifies the declining guest and provides the name for storage as a rejecting guest.

However, if it is determined in step 114 that the guest has accepted the invitation, the method moves to step 120, where the name and number of guests invited by the electronic invitation are inputted by the guest into the guest interface module 28 through the guest terminal. Next, in step 122, the computing system stores the guest name and number in the database 26. In step 124, it is determined if the guest desires additional information relevant to the wedding. If it is determined that the guest does not desire information, the method remains at step 124 until the guest desires information or the computing system transitions to the commemorative mode.

However, if it is determined in step 124 that the guest desires additional information on the wedding, the method moves to step 126 where the guest communicates with the computing system 22. The guest may communicate with the computing system through any terminal connecting via a communications link to the computing system. The electronic invitation may provide a hyperlink or prompt to the wedding web site generated by the computing system. In addition, a web address may be provided within the electronic invitation for which the guest may manually enter to reach the wedding web site.

Alternatively, the guest may be supplied information through the voice interface module 29. The guest may access the voice interface module through any telephone 31 which connects either through a landline or wireless connection with the voice interface module. The telephone number may be displayed on the wedding web site or on the electronic invitation. The guest may verbally ask the voice interface module for more information. The voice interface module receives the request and interprets the words. Upon recognizing and interpreting the requested information, the voice interface module seizes the appropriate information from the database 26, converts the desired information into verbal language and transmits the information to the guest through the telephone. For example, the guest may request the specific time of the wedding ceremony, the location of the wedding, or driving directions to the wedding.

Next, in step 128 it is determined if the host desires to enter information or communicate with the computing system 22. The host may desire to modify or add information concerning the wedding. Additionally, the host may desire to obtain information from the computing system. For example, additional accommodations may be found or changes in details of the events of the wedding may have been implemented. If it is determined that the host desires to change information, the method moves from step 128 to step 130 where the host accesses the computing system through the administration module 24 and inputs the desired changes or obtains information. If necessary, the host may change information on the wedding web site as desired. The method then moves from step 128 to step 124.

However, if the host does not desire to change information or communicate with the computing system 22, the method moves from step 128 to step 132 where it is determined if the wedding has ended. The completion of the wedding may be determined by the computing system automatically after the selected date of the wedding has passed or the host may manually enter the information of the passage of the wedding. If it is determined that the wedding has not passed, the method moves to step 124.

However, if it is determined that the wedding has passed, the method moves from step 132 to step 134 where the computing system transitions the wedding web site to a commemorative mode. Within the commemorative mode, the web site memorializes the events of the wedding, such as providing the names of the guests attending the wedding and photographs of the wedding and honeymoon. The host may enter photographs or other pertinent data for viewing on the web site. Next, the method moves to step 136 where it is determined that a specified period of time has passed since the passage of the wedding. The specified period of time may be entered by the host or determined by the computing system 22. If it is determined that the specified period of time has not passed, the method remains at step 136 until the specified period of time has passed.

However, if it is determined that the specified period of time has passed, the method moves from step 136 to step 138 where the computing system generates a memorialization of the wedding on a storage device, such as a CD or mini-disc. The memorization may include photographs, the electronic invitation and list of attending guests.

Although a wedding has been discussed in use with the system 20, the system 20 may be used with any type of event, such as a graduation, anniversary, seminar, or baptism. Additionally, the system 20 may or may not include the voice interface module.

The system 20 provides many advantages to the host and guests of an event. The system 20 enables the host to efficiently and effectively disseminate information in a timely and creative manner. The electronic invitation provides for a multimedia presentation allowing the guest to enjoy the receipt of the invitation. Additionally, the system 20 allows the guest to gather information, and if necessary, query the system 20 for additional information from several conduits, such as the telephone or any computer terminal.

It is thus believed that the operation and construction of the present invention will be apparent from the foregoing description. While the method and system shown and described have been characterized as being preferred, it will be readily apparent that various changes and modifications could be made therein without departing from the scope of the invention as defined in the following claims.

What is claimed is:

1. A system for disseminating information about an event, said system comprising:
a computing system having means for disseminating information about an event to a host and a guest;
a host terminal having means for communicating with said computing system, said host terminal operated by the host of the event; and
a guest terminal having means for communicating with said computing system, said guest terminal operated by the guest of the event;
said computing system storing information about the event and generating an electronic invitation on the event for the guest.

2. The system for disseminating information about an event of claim 1 wherein the means for communication by said host terminal and said guest terminal is via the Internet.

3. The system for disseminating information about an event of claim 1 wherein the computing system includes a voice interface module providing verbal information, said voice interface module responsive to verbal requests for verbal information.

4. The system for disseminating information about an event of claim 3 wherein the guest may access the voice interface module via a telephone.

5. The system for disseminating information about an event of claim 3 wherein the voice interface module may provide driving directions responsive to a request for directions from a guest.

6. The system for disseminating information about an event of claim 3 wherein the voice interface module may be accessed via a computer.

7. The system for disseminating information about an event of claim 1 wherein the computing system generates an electronic invitation for inviting the guest to the event.

8. The system for disseminating information about an event of claim 7 wherein the electronic invitation is an electronic storage device mailed to the guest.

9. The system for disseminating information about an event of claim 7 wherein the electronic invitation is an email message.

10. The system for disseminating information about an event of claim 7 wherein the electronic invitation includes an audio recording.

11. The system for disseminating information about an event of claim 7 wherein the electronic invitation includes a visual display.

12. The system for disseminating information about an event of claim 7 wherein the electronic invitation includes a visual display and an audio recording.

13. The system for disseminating information about an event of claim 7 wherein the electronic invitation includes a response prompt for communicating with the computing system an intent of the guest in attending the event.

14. The system for disseminating information about an event of claim 13 whereby, upon receipt of a response from the guest, said computing system automatically compiles a guest list of guests intending to attend the event.

15. The system for disseminating information about an event of claim 1 wherein the computing system generates a web site for disseminating information about the event.

16. The system for disseminating information about an event of claim 15 wherein said web site is accessible by the guest.

17. The system for disseminating information about an event of claim 15 wherein said web site is accessible by the host.

18. The system for disseminating information about an event of claim 17 wherein the web site is modifiable by the host.

19. The system for disseminating information about an event of claim 15 wherein the web site provides interactive driving directions to the event.

20. The system for disseminating information about an event of claim 15 wherein the web site provides information of accommodations near a location of the event.

21. The system for disseminating information about an event of claim 15 wherein the web site converts to a commemorative mode memorizing the event after passage of the event.

22. The system for disseminating information about an event of claim 1 wherein the computing system, upon passage of the event, generates a memorialization of the event.

23. The system for disseminating information about an event of claim 22 wherein the memorialization of the event is stored on a compact disc.

24. The system for disseminating information about an event of claim 22 wherein the memorialization of the event is stored on an electronic storage media device.

25. A system for disseminating information about an event, said system comprising:
a computing system having means for disseminating information about an event to a host and guests;
a host terminal having means for communicating with said computing system, said host terminal operated by the host of the event; and
a guest terminal having means for communicating with said computing system, said guest terminal operated by the guest of the event;
said computing system storing information about the event and generating an electronic invitation on the event for the guest, the electronic invitation having a response prompt for communicating with the computing system an intent of the guest in attending the event, said computing system compiling a list of guests intending on attending the event;
said computing system generating a web site for disseminating information about the event.

26. A method of disseminating information about an event to a guest from a host hosting the event, said method comprising the steps of:
inputting information about the event by the host to a computing system;
storing the inputted information by the computing system;
generating, by the computing system, an electronic invitation from the host for the guest, the electronic invitation including information about the event;
delivering the electronic invitation to the guest;
sending a response on the guest's intention in attending the event by the guest to the computing system;
generating, by the computing system, a web site providing details on the event; and
accessing by the guest the web site to gain additional details of the event.

27. The method of disseminating information about an event to a guest from a host hosting the event of claim 26 further comprising, after the step of sending a response on the guest's intention in attending the event, the step of compiling a list of several guests responding with intentions in attending the event.

28. The method of disseminating information about an event to a guest from a host hosting the event of claim 26 further comprising, after the step of generating a web site, the step of transitioning to a commemorative mode displaying information on the event once the event is completed.

29. The method of disseminating information about an event to a guest from a host hosting the event of claim 26 further comprising the step of generating a memorization of the event after passage of the event.
